(19) United States
(12) Patent Application Publication
(10) Pub. No.: US 2013/0238359 A1
(43) Pub. Date: Sep. 12, 2013

(54) BI-DIRECTIONAL BIOMARKER BASED CLINICAL TRIAL MATCHER

(71) Applicants: Jennifer L. Carter, Waltham, MA (US); Paul Ferraiolo, Waltham, MA (US)

(72) Inventors: Jennifer L. Carter, Waltham, MA (US); Paul Ferraiolo, Waltham, MA (US)

(21) Appl. No.: 13/789,196

(22) Filed: Mar. 7, 2013

Related U.S. Application Data
(60) Provisional application No. 61/607,650, filed on Mar. 7, 2012.

(51) Int. Cl. G06F 19/00; G06Q 50/24

(52) U.S. Cl. CPC G06F 19/366; G06Q 50/24
USPC 705/3

(57) ABSTRACT

A computer-based system configured to organize, analyze, locate and distribute information related to clinical trials is described herein. More particularly, a computer-based system for providing a bi-directional clinical trial matching process (e.g., locate patients based on trial information or locate trials based on patient information) based on biomarkers associated with both a patient and a clinical trial are described herein.

### CROSS-REFERENCE TO RELATED APPLICATIONS

This application claims the benefit under 35 U.S.C. §119(e) of U.S. Provisional Application No. 61/607,650, filed Mar. 7, 2012, the content of which is incorporated herein by reference in its entirety.

### TECHNICAL FIELD

A computer-based system configured to organize, analyze, locate and distribute information related to clinical trials is described herein. More particularly, a computer-based system for providing a bi-directional clinical trial matching process (e.g., locate patients based on trial information or locate trials based on patient information) based on biomarkers associated with both patients and clinical trials is described herein.

### BACKGROUND

Cancer affects millions of people each year. Annually, about 1.4 million people are diagnosed with cancer in the United States. On average, sixteen million Americans live with cancer each day. Of these, about one half million will die annually. Yet, each case is exceedingly personal. Cancer research has shown that a cancer that affects one person is often quite different from a cancer that affects another person. Even in the same organ or within a single patient, cancer cells can be dramatically different at the molecular level due to differences in each individual's tumor genetics.

Until recently, traditional cancer treatments have been based on the results of clinical trials with “large N's,” the trial vernacular for large “numbers” of patients. However, such an approach may not always be appropriate for many of the individuals who suffer from cancer. In particular, each tumor/cancer has its own unique genetic and molecular signature, which explains why in certain instances, patients with the same type of cancer often experience dramatic differences in their response to chemotherapy or treatment. Recent advances in the study of tumor biology have allowed for greater molecular insight into the tumor biology within individual patients, leading to treatments that can prolong and even save lives.

Due to the differences in the way cancer can affect one individual compared to another individual, it can be difficult to identify suitable participants for clinical trials. Currently in order to receive FDA approval, a drug must undergo extensive human clinical trials. In some estimates, the time for clinical trials can be up to 50% of the time required for drug to come to market. One difficulty in clinical trials is identification and enrollment of participants for the trial because not all individuals having a particular type of cancer will be suitable for enrollment in the clinical trial.

### SUMMARY

A computer based system for generating and outputting information relating to clinical trials is described herein. The computer-based system includes software for providing bi-directional clinical trial matching (e.g., locate patients based on clinical trial information or locate clinical trials based on patient information) based on biomarkers associated with both patients and clinical trials are described herein. The system includes a clinical trial database storing information about clinical trials including a disease associated with the clinical trial and molecular markers associated with the clinical trials. The system also includes a patient database that includes information about patients including demographic information, disease information, and molecular markers identified as present or absent for the individual based on molecular testing. Based on the information in these databases, providers and patients can search for clinical trials that are applicable to their specific disease/molecular marker combination and those administering clinical trials (e.g., hospitals, physicians, drug development companies) can search for patients diagnosed with the specific disease and having positive results for the molecular markers targeted in a relevant clinical trial.

Methods of using the computer system to identify patients for clinical trials and clinical trials for patients are also provided. In one embodiment, provided is a computer-implemented method for matching a patient for a clinical trial, comprising: accessing, by a computer, a patient database comprising, for each of a plurality of patients, (a) electronic patient records comprising a patient identifier, a diagnosed disease and demographic information, and (b) testing results for one or more biomarkers; accessing a clinical trial database comprising, for each of a plurality of clinical trials, (a) clinical trial records comprising a trial identifier, targeted disease, locations, (b) one or more biomarkers targeted by the clinical trial and (c) criteria on how testing results of the one or more biomarkers correlate with clinical trial outcomes; and identifying a patient from the patient database as a suitable candidate patient for a clinical trial in the clinical trial database by matching the patient's disease, demographic information, and biomarker testing results with the clinical trial's target disease, locations and targeted biomarkers, respectively, wherein the matching of the biomarkers takes into consideration of the criteria such that the patient's testing results for the biomarkers predict positive outcomes from the clinical trial.

In one embodiment, the system receives a request for identifying a candidate patient for a clinical trial; obtains, for the clinical trial, clinical trial records comprising (a) targeted disease, locations, (b) one or more biomarkers targeted by the clinical trial and (c) criteria on how testing results of the one or more biomarkers correlate with clinical trial outcomes; accesses the patient database; and identifies a patient from the patient database as the candidate patient, wherein the patient matches the clinical trial with respect to the clinical trial's target disease, locations and targeted biomarkers, and wherein the matching of the biomarkers takes into consideration of the criteria such that the patient's testing results for the biomarkers predict positive outcomes from the clinical trial.

In one embodiment, the system receives a request for identifying a candidate clinical trial for a patient; obtains, for the patient, (a) a diagnosed disease and demographic information, and (b) testing results for one or more biomarkers; accesses the clinical trial database; and identifies a clinical trial from the clinical trial database as the candidate clinical trial, wherein the patient matches the clinical trial with respect to the patient's disease, demographic information and biomarkers, and wherein the matching of the biomarkers takes into consideration of the criteria such that the patient's testing results for the biomarkers predict positive outcomes from the clinical trial.

### BRIEF DESCRIPTION OF DRAWINGS

FIG. 1 is a schematic diagram of a computer system including a patient database, a clinical trial database, and a matching unit.

FIG. 2 is a schematic representation of information included in a patient data record.

FIG. 3 is a schematic representation of information included in a clinical trial record.

FIGS. 4A and 4B are flow charts of a computer implemented clinical trial matching processes.

FIG. 5 is a schematic diagram of links between a patient and a clinical trial.

FIG. 6 is a schematic diagram of links between a patient and a clinical trial.

FIG. 7 is a schematic diagram of links between a patient and a clinical trial.

### DESCRIPTION

Described herein is a computer-based system that provides a centralized resource for bi-directional clinical trial matching. Using this system, physicians and patients can locate clinical trials that are relevant to their specific disease state (e.g., clinical trials targeting biomarkers applicable to the patient and/or targeting the patient's disease) and clinical trial administrators can locate patients having disease states and other factors relevant to their trials (e.g., exhibiting biomarkers targeted by the clinical trial, diagnosed with the disease targeted by the clinical trial, located in the relevant location, etc.). Additionally, information in the clinical trial database allows physicians and patients to quickly and easily access information about molecular markers, leading-edge testing laboratories, new and potentially relevant therapeutic drugs, clinical trials, and the world's top cancer experts in order to identify treatments that may not otherwise be considered.

In general, each cancer type will have an associated set of molecular markers that are relevant to that type of cancer. It can be beneficial to match patients with clinical trials based on the biomarkers. In general, a biomarker is a biological entity that by its presence, absence, or level can provide information about disease prognosis or predict response or resistance to a particular therapy. A biomarker may be a gene (DNA), an RNA, a protein, or another small molecule. The testing result(s) for a biomarker may be the presence, absence or level of the gene or protein or molecule itself, or it may be a modification of the entity, such as a mutation or chemical modification (such as phosphorylation, methylation, etc). It may be a cellular molecule, or a molecule that is circulating in the bloodstream. Data may exist that links a biomarker to a particular therapy or clinical trial. In that case, the presence or absence of a biomarker in a patient or patient's tumor may be used to link that patient to a clinical trial or therapeutic strategy. The presence, absence, or level of a biomarker may be assessed by a number of different biochemical techniques, including but not limited to DNA or RNA sequencing, polymerase chain reaction (PCR), immunohistochemistry (IHC), fluorescence in situ hybridization (FISH), array comparative genome hybridization (aCGH), circulating tumor cell analysis (CTC), circulating DNA, multiplex analytic technologies, microRNA analysis, and other methods known in the art. In the computer-based system, each molecular marker can be defined and can have an accompanying rationale for testing in that cancer type supported by evidence from medical and scientific literature. Such literature references can be linked to an external site such as the public database supported by the National Institute of Health such that clicking on a reference will link a user to the resources about that scientific reference.

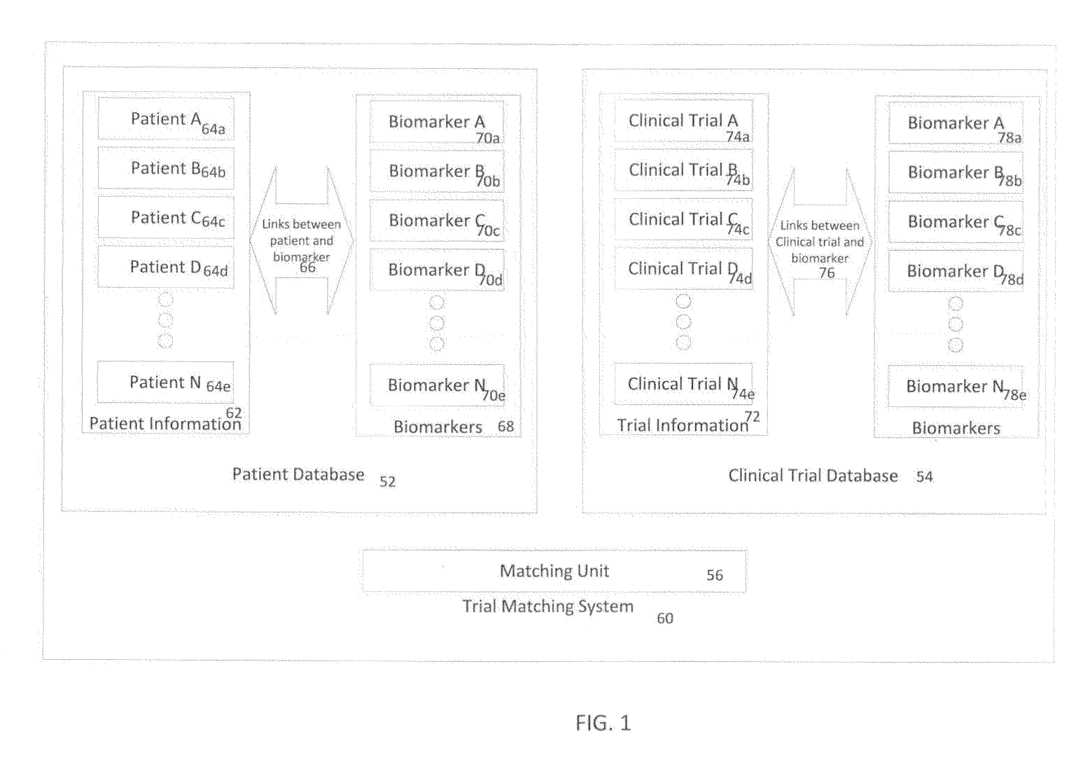

FIG. 1 shows an exemplary computer-based clinical trial matching system 60. The trial matching system 60 includes a patient database 52 stored in a memory of the computer system and a clinical trial database 54 stored in a memory of the computer system. The clinical trial matching system 60 also includes a matching unit 56. Matching unit 56 can be, for example, software stored in a memory on the computer system that is configured to match patients with clinical trials based on biomarkers that are linked to both the patient and the clinical trial. Thus, the matching unit 56 can identify clinical trials based on patient information and can identify patients based on clinical trial information.

As noted above, both patients and clinical trials are linked to biomarkers. More particularly patient database 52 includes patient information 62 that is linked to biomarkers 68. The patient information 62 can include information about multiple different patients (e.g., patients 64a, 64b, 64c, 64d, and 64e). The patient database 52 also includes biomarker information 68 (e.g., biomarkers 70a-e) and links between the patients and particular biomarkers exhibited by the patients.

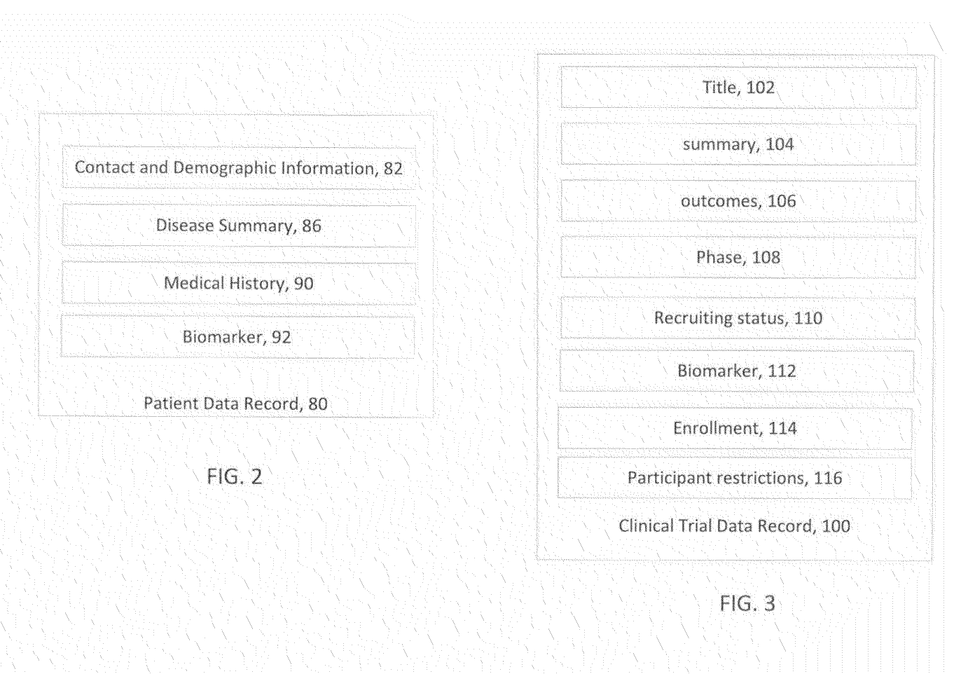

In one particular example, as shown in FIG. 2, the patient information 62 in the patient database 52 can include multiple patient data records 80 with each patient data record associated with a particular patient. The patient data records can include a patient's demographic information 82, medical history 90, disease summary 86 including treatment history and pathology information, and biomarker information 92. As such, in this example, the patient is linked to the relevant biomarkers by an entry in the patient data record 80 for the patient. Each patient data record 80 can include multiple different relevant biomarkers. Medical documents, such as scans or pathology reports, could also be associated with the patient data record 80. The patient data record 80 can additionally/alternatively be linked to electronic medical records for ease of transfer of patient information including demographics, pathology reports, radiology reports and treatment history.

Referring back to FIG. 1, the trial matching system 60 also includes a clinical trial database 54. The clinical trial database 54 can include links between clinical trials and biomarkers targeted by the clinical trials (as shown by arrow 76). In one particular example, as shown in FIG. 3, the clinical trial database can include multiple clinical trial data records 100 with each record being associated with a particular clinical trial. The clinical trial data record 100 can include the title of the clinical trial 102, a summary of the clinical trial 104, outcomes of the clinical trial 106, the phase of the clinical trial 108, recruiting status of the clinical trial 110, biomarkers targeted by the clinical trial 112, information about enrollment for the clinical trial 114, and/or participant restrictions 116. Thus, the clinical trial data record 100 itself includes information about biomarkers 112 targeted by the drug associated with the clinical trial.

Information in the clinical trial database 54, including a list of current clinical trials, can be obtained from external sources such as the National Institute of Health and the National Cancer Institute. Additionally information can be obtained from trial sponsors such as the pharmaceutical and biotechnology companies in the academic institution and principal investigators of the study. Such available information can include the drugs being tested, mechanisms of action, disease type, eligibility information, biomarker testing requirements and/or associations, rationale for development, and any other relevant information specific to each individual trial. Results of previous clinical trials for the relevant drugs can also be accessible for review. This information can be accessed by the computer system to perform clinical trial matching between patients and clinical trials.

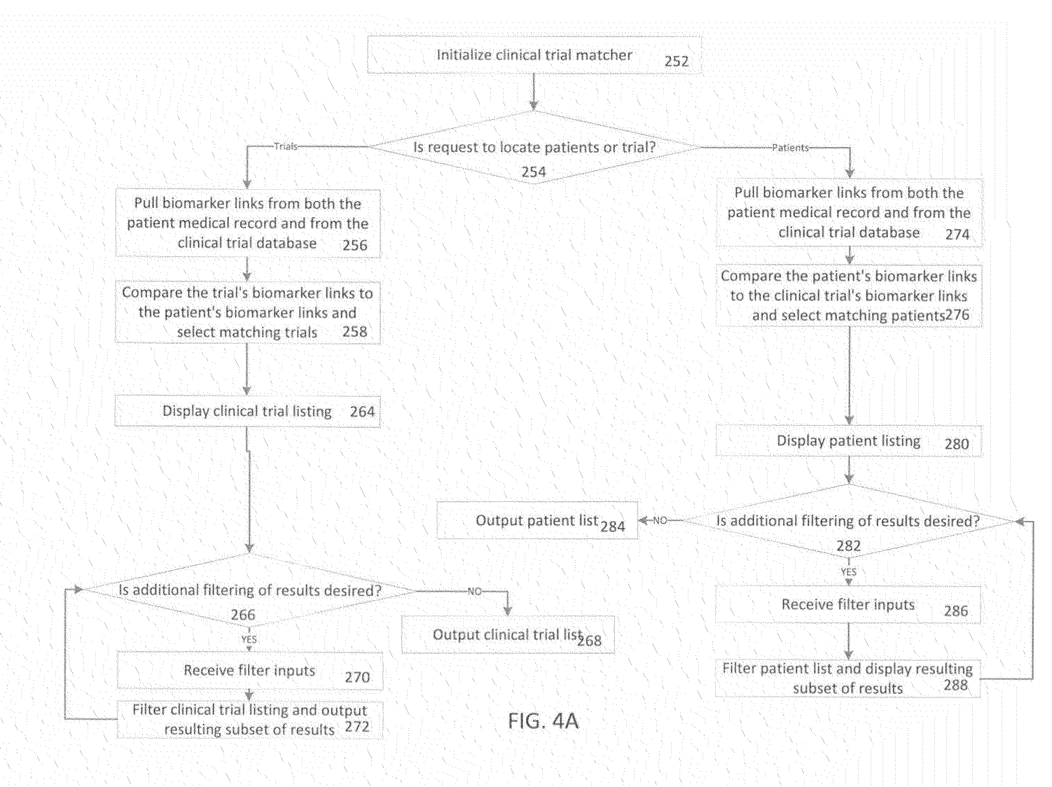

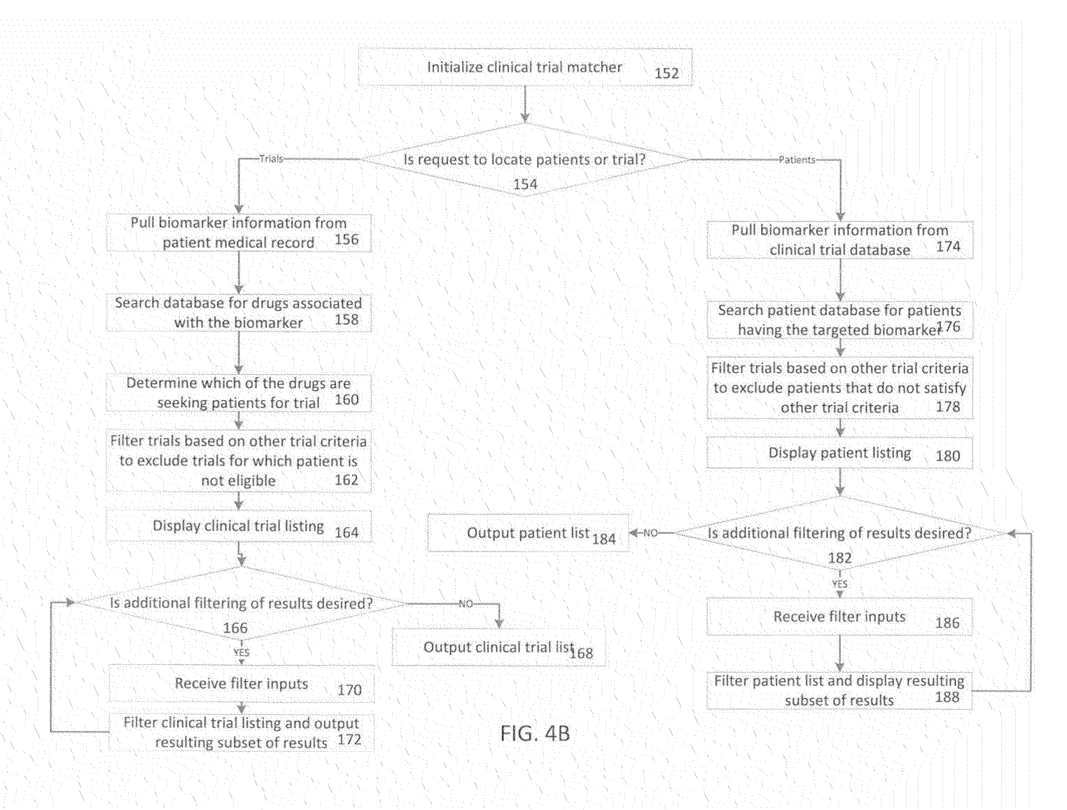

FIG. 4A shows a flowchart of a clinical trial matching process 250 process 250 includes initializing a clinical trial matcher (252) such as the matching unit 56 shown in FIG. 1. After initialization, the computer system receives a request to locate potential participants for a clinical trial or to locate a clinical trial that may be relevant to a particular patient. The system determines whether the request is a request to locate participants or a request to locate the clinical trial (254). If the request is a request to locate a clinical trial such as a request from the patient having a particular disease and a particular set of biomarkers that is interested in locating clinical trials that could be relevant to their specific disease and biomarker combination. The computer system pulls biomarker links from both the patient medical record and from the clinical trial database (256). Based on the information, the system compares the trial's biomarker links to the patient's biomarker links and select matching trials (258). This results in the system generating a set of clinical trials that is potentially relevant to the patient. Subsequently, the system displays or outputs the clinical trial listing that includes clinical trials which may be applicable to the patient (264).

In some embodiments, either in the clinical database, the patient database, or somewhere accessible to the present system, provided is matching criteria for biomarkers for a clinical trial. The “matching criteria” as used herein, refers to an association or correlation between the testing results of one or more biomarkers and a clinical outcome of the clinical trial. For instance, the criteria can be expressed as if genes A and B are mutated, then the patient is likely experience positive outcome from the corresponding clinical trial. Accordingly, when matching a patient with a clinical trial, the matching criteria is taken into consideration based on the biomarkers shared between the patient and the clinical trial.

In some situations a patient may desire to further restrict the listing of clinical trials based on additional factors. For example if a patient lives in Boston they may not be interested in viewing clinical trials which would require frequent visits to hospitals in Indianapolis. In order to provide a listing of clinical trials of interest to the patient, the system determines if additional filtering of the results is desired (266). For example, the system can allow the user to input additional restrictions that would limit the clinical trials. The system receives the filter inputs from the user (270) and filters the previously generated clinical trial listing to output a resulting subset of the results based on the inputted filter (272). If the system determines that additional filtering of the results is not desired (266), the system outputs the clinical trial list to the user (268). Thus, based on information from the patient medical record, the system is able to identify and filter clinical trials that may be applicable and of interest to a particular patient.

On the other hand, if the request is a request to locate potential trial participants (154), the system pulls biomarker links from both the patient medical record and from the clinical trial database (274). The system compares the patient's biomarker links to the clinical trial's biomarker links and select matching patients (276). The system outputs this patient listing to the user (180).

In some examples the user who is attempting to locate participants for a particular clinical trial may desire to further filter the results from the displayed patient listing. For example, if the clinical trial is seeking to enroll only 20 participants in the clinical trial and 100 potential participants are identified, it may be desirable to further limit the listing of potential patients such that patients having greater relevance to the study or greater likelihood of participating in the study can be identified. Thus, the system determines that additional filtering of the results is desired (282). If additional filtering of results is not desired, the system outputs the patient list (284). If additional filtering of the results is desired, the system receives the filter inputs (286) and filters the patient list to display the resulting subset of the results. For example the system can access information in the patient data records to determine if the patient satisfies the filter criteria. Thus, based on information from the patient medical records, the system is able to identify and filter potential participants that may be applicable to a particular clinical trial.

FIG. 4 shows a flowchart of a clinical trial matching process 150 process 150 includes initializing a clinical trial matcher (152) such as the matching unit 56 shown in FIG. 1. After initialization, the computer system receives a request to locate potential participants for a clinical trial or to locate a clinical trial that may be relevant to a particular patient. The system determines whether the request is a request to locate participants or a request to locate the clinical trial (154). If the request is a request to locate a clinical trial such as a request from the patient having a particular disease and a particular set of biomarkers that is interested in locating clinical trials that could be relevant to their specific disease and biomarker combination. The computer system pulls biomarker information from the patient medical record (156). For example, the system accesses the medical data record for the patient to obtain information included therein. This information can include a listing of biomarkers for which a positive result has been obtained. Additionally, this information can include the disease with which the patient has been diagnosed. Based on the information about the patient from the patient's medical record, the system searches the database for drugs undergoing clinical trials that are also associated with the identified biomarker(s) (158). This result in the system generating a set of clinical trials that is potentially relevant to the patient.

After identifying relevant clinical trials, the system determines which of the clinical trials are seeking additional participants at the current time (160). This information can be obtained from the enrollment information in a clinical trial data record. For example, for each identified clinical trial the computer system can access the clinical trial record to determine whether the enrollment status indicates that enrollment is open for the trial. The system filters removes) the trials that are not accepting participants from the list of potentially applicable trials. This generates a list of trials open for enrollment for which a match exists to the patient's biomarkers.

As noted above, clinical trials may additionally restrict enrollment in the trial based on factors such as gender, age, disease, or other patient specific information. After identifying relevant trials which are currently accepting or seeking participants in the clinical trial, the system filters these trial results based on additional trial criteria to exclude trials for which the patient is not eligible (162). For example, if the patient searching for clinical trials exhibits the biomarkers associated with the clinical trial but the clinical trial restricts enrollment to only female participants and the patient is a male, then the system filters the clinical trial results to remove this particular clinical trial from the list of potentially applicable clinical trials. In another example, if a patient searching for clinical trials exhibits the biomarkers associated with a particular trial but the clinical trial restricts enrollment to only participants having been diagnosed with a particular type of cancer, and the patient has not been diagnosed with that particular type of cancer, then the system can filter the clinical trial results to remove this particular clinical trial from the list of potentially applicable clinical trials. While not shown in the flowchart shown in FIG. 4, clinical trials which have been filtered out based on such trial criteria, can be displayed separately to the patient and the patient can review the clinical trials even though they are unlikely to be eligible to participate in them.

After filtering the clinical trials based on the trial criteria (162), the system displays or outputs the clinical trial listing that includes clinical trials which may be applicable to the patient (164).

In some situations a physician and/or patient may desire to further restrict the listing of clinical trials based on additional factors. For example if a patient lives in Boston they may not be interested in viewing clinical trials which would require frequent visits to hospitals in Indianapolis. In order to provide a listing of clinical trials of interest to the physician and/or patient, the system determines if additional filtering of the results is desired (166). For example, the system can allow the user to input additional restrictions that would limit the clinical trials. The system receives the filter inputs from the user (170) and filters the previously generated clinical trial listing to output a resulting subset of the results based on the inputted filter (172). If the system determines that additional filtering of the results is not desired (166), the system outputs the clinical trial list to the user (168). Thus, based on information from the patient medical record, the system is able to identify and filter clinical trials that may be applicable and of interest to a particular patient.

On the other hand, if the request is a request to locate potential trial participants (154), the system pulls biomarker information about a particular clinical trial which is seeking to identify participants for the trial (174). For example, the system can access information in the clinical trial data record and return the biomarkers identified in the record. The system searches the patient database for patients having the identified biomarker for the clinical trial (176). For example, the system accesses biomarker information in patient data records and returns a set of patient records having at least one biomarker in common with the identified biomarker for the clinical trial. The system subsequently filters the set of identified potential participants based on additional clinical trial criteria to exclude patients that do not satisfy other criteria for participation in the clinical trial (178). For example the system accesses a set of one or more additional restrictions in the clinical trial record and compares the restriction to information in each of the identified patient records. If the information in the patient record does not satisfy the restrictions, then the patient is removed from the list of potential participants for the study. The system outputs this patient listing to the user (180).

In some examples the user who is attempting to locate participants for a particular clinical trial may desire to further filter the results from the displayed patient listing. For example, if the clinical trial is seeking to enroll only 20 participants in the clinical trial and 100 potential participants are identified, it may be desirable to further limit the listing of potential patients such that patients having greater relevance to the study or greater likelihood of participating in the study can be identified. Thus, the system determines that additional filtering of the results is desired (182). If additional filtering of results is not desired, the system outputs the patient list (184). If additional filtering of the results is desired, the system receives the filter inputs (186) and filters the patient list to display the resulting subset of the results. For example the system can access information in the patient data records to determine if the patient satisfies the filter criteria. Thus, based on information from the patient medical records, the system is able to identify and filter potential participants that may be applicable to a particular clinical trial.

As described above, the bidirectional clinical trial matching process can be based on links between a patient and a biomarker and links between a clinical trial and a biomarker. For example, FIG. 5 shows a patient record 200 that is linked to a biomarker 204 as represented by arrow 202. The biomarker 204 is also linked to a clinical trial 208 as represented by arrow 206. Thus, both the patient 200 and the trial 208 are linked to the same biomarker 204 enabling the computer system to bi-directionally match the trial with the patients and/or the patients with the trial. The links between the patient 200 and biomarker 204 and the links between the biomarker 204 and the clinical trials 208 can be explicit links within the system and/or biomarker information can be included in both a patient record and the trial record such that the link can be made by the system based on searching for particular biomarker.

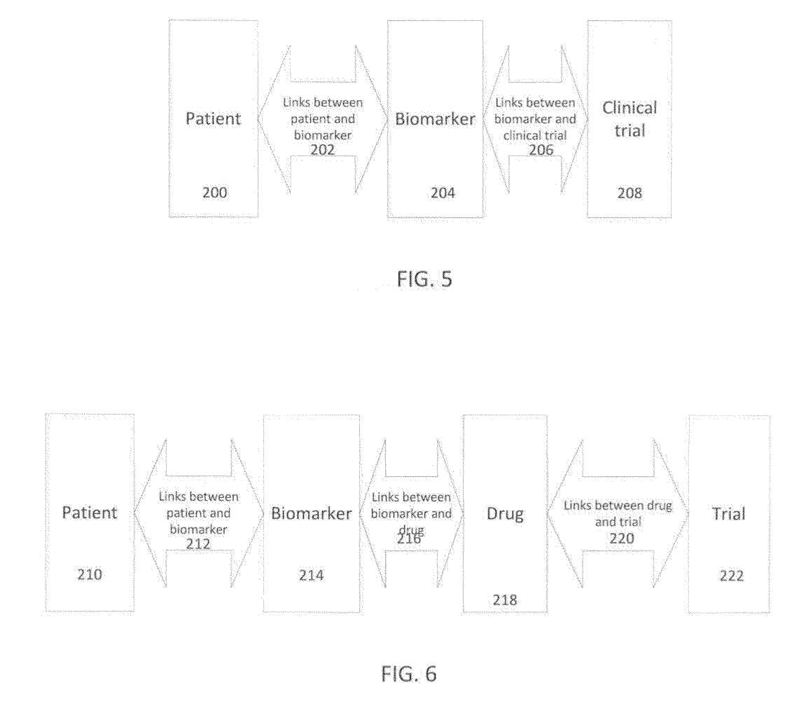

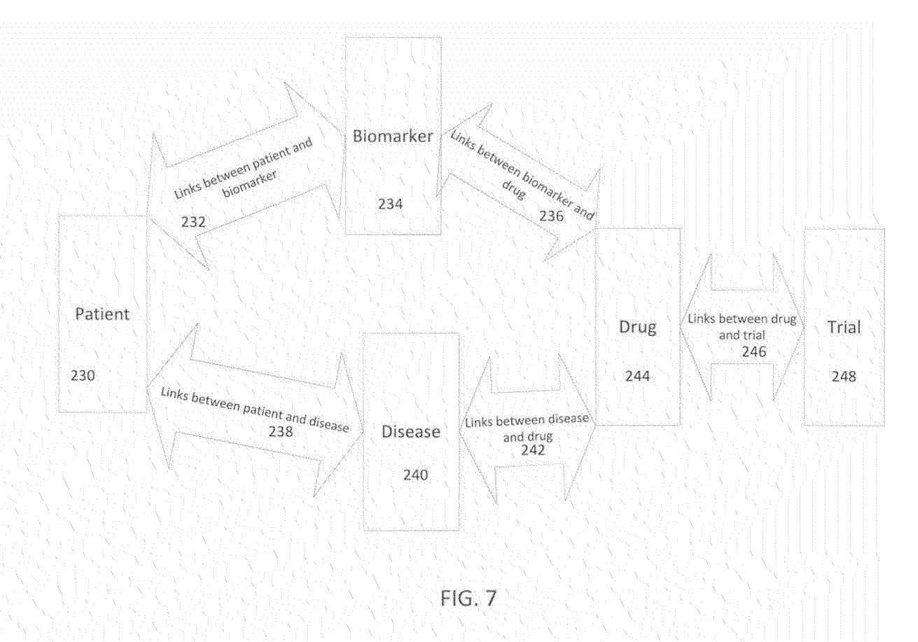

While in the examples shown above the clinical trial matcher is based on links that associate both patients and clinical trials to the same set of biomarkers, other links can provide the information used by the clinical trial matcher. In one such example, as shown in FIG. 6, a patient 210 can be linked to a particular biomarker 214 as indicated by arrow 212. The biomarker 214 can be linked to a particular drug 218 as shown by arrow 216. The drug in turn is linked to a particular clinical trial 222 as shown by arrow 220. In another example, as shown in FIG. 7, the matching between a patient and the clinical trial can be based on multiple different criteria. In this example, patient 230 is linked to both a biomarker 234 and a disease 240 as indicated by arrows 232 and 238. These biomarkers and diseases are in turn linked to a drug 244 as indicated by arrows 236 and 242. In order to provide the associations need necessary to link the patient to the clinical trial, the drug 244 is linked to the clinical trial 248 as indicated by arrow 246. During the matching process, the system can require that both the linkage between the patient and the drug through the biomarker 234 and the disease 240 be present in order for the match to be identified. Thus, in this example, matches will be identified only when the patient and the drug have both a biomarker 234 and a disease 240 in common.

In the example shown above, each of the linkages between the patient's and clinical trials is based at least in part on biomarker information linked either directly or indirectly with both the patient and the clinical trial. Thus, because the biomarker provides the linkage between the two data sets, the molecular test data is key to allowing appropriate matches between patients and clinical trials to be performed. Additionally, because the patient and the clinical trial are both associated with the common data point, the clinical trial matcher can provide bidirectional matching in order to identify clinical trials that may be relevant to a particular patient and/or to match patients to clinical trials to identify potential participants in the trials.

In some additional examples, a patient searching for clinical trials applicable to their particular biomarkers and/or disease states may not be successful in identifying trials of interest at a particular time (e.g., relevant trials may not exist). In such examples, the system can store information about the physician and/or patient's search and update search results at a later time based on newly added clinical trials. For example, if an individual searches for a clinical trial, the system can store information about the search which indicates the individual's interest in clinical trials. The system can also receive an indication from the physician and/or patient about his preferences for receiving updates. For example the patient can indicate that he desires to receive no updates, desires monthly updates, desires daily updates, or desires updates as new trials become available and/or his information is updated. When additional clinical trials are added to the system, the system can determine whether the clinical trial would satisfy the previously entered search criteria. If so, the system can push the information about the clinical trial to the user for example by e-mail or text message or information displayed on the user's account without requiring the user to perform an additional search. In some additional examples, if information about the particular patient is updated to include one or more new biomarkers and/or one or more new disease states, this information can be used to run an additional search of the clinical trials available to see if the user would potentially qualify for any clinical trials that were not previously identified. If so, the system can push this information to the individual for example by e-mail or text message or information displayed on the user's account.

In some additional examples, an administrator of a clinical trial may search for potential participants at a particular time and not identify a satisfactory number of potential participants. If at a later time enrollment in the clinical trial is still open, the system can automatically update a list of potential participants based on updated information about patients in the system's database and/or based on information about patients added to the database subsequent to the initial search for participants. This information can automatically be pushed to the clinical trial administrator for example by e-mail, text message and/or information displayed on the account.

In some additional examples, the system can also include a diagnostic roadmap generation process and a treatment roadmap generation process that process and synthesize information from the database to provide decision-making assistance to physicians and patients regarding the most appropriate diagnostic tests and treatments for the patient's particular cancer. Examples of diagnostic and treatment roadmaps as well as processes for generating diagnostic and treatment roadmaps is described for example in U.S. patent application Ser. No. 13/151,830 filed on Jun. 2, 2011 entitled Personalized Cancer Therapy, the contents of which is hereby incorporated by reference in its entirety. The diagnostic and treatment roadmaps can be further supplemented by information about the clinical trials. For example, if an individual has a particular disease for which clinical trials exist but testing has not been done to determine whether the patient exhibits the biomarkers targeted by the particular clinical trial, a diagnostic roadmap can include suggestions for testing to determine whether the patient exhibits a positive indication of the biomarker. In another example, because information exists linking clinical trials to biomarkers, when a treatment roadmap is developed, the treatment roadmap can include information about clinical trials which may be available to the individual based on biomarkers exhibited by the individual. Thus, in addition to allowing bidirectional searching for participants and clinical trials, the clinical trial manager can additionally be used in conjunction with a roadmap generation process to include information about clinical trials in diagnostic and treatment roadmaps developed for a particular individual.

Interfaces are provided to display medical records for patients. The patient's medical record can include identifying information such as a case number and name of an individual. The patient's medical record can also include demographic information such as the patient address, date of birth, and sex. Patient medical record can also include information about the patient's diagnosis and the status of the case for example whether the patient case is still active or has ceased to be active. Additionally, the patient's medical record can include notes to assist in a quick understanding of the status of the patient. In some examples the patient's information can also include insurance information such as the provider, policy number, group number, and any secondary providers and the associated information about those providers. The demographic information shown on this page may contribute to search criteria for clinical trial matching. The age, sex, status, and location of the patient may all be used as filters for clinical trial identification.

In some embodiments, a patient's medical record can also include pathology reports. The pathology can reports can include links to different lab collections and testing that have been performed. Selection of such a link will include identification of the tissue sample. Many patients will have multiple biopsies and procedures, resulting in multiple tissue samples and pathology reports. Patients may also have multiple rounds of testing on different tissue samples. This page allows the organization of all the tissue and pathology reports, allowing the clear association of specific tests and results to particular tissue samples. This can be important if there are multiple lesions with different molecular profile—a physician may choose to treat based on the molecular profile of a lesion that is actively progressing rather than one that is indolent.

The patient's medical record can additionally include the information about test requisitions and their results. This can include various diagnostic labs that have been performed, test ordered, the date of the tests, and the results of those tests. The test results can include the identification of various biomarkers and whether the biomarker result is positive or negative. This page serves as the central repository for all the tests done for a patient. It allows every test to be associated with a specific tissue sample and a specific laboratory and test requisition. It is a critical component for record-keeping of the molecular tests and results. The results recorded on this page serve as the basis for bi-directional trial matching.

In some embodiments, the patient medical record can also include a patient summary. The patient summary can include information about tissue samples that have been collected, tests that have been ordered, and test results. The test results again, can include information about biomarkers and whether the biomarker test result was positive or negative. Where the previous page shows tests individually, this page displays a complete picture of the molecular profile for a patient, allowing the doctor or patient to get a glimpse of the complete testing results and molecular profile at once.

In some embodiments, the system is able to leverage a patient's molecular test results in order to generate high-quality reports containing the most up-to-date scientific data related to the patient's specific molecular profile

In some embodiments, the system enables a physician or patient to identify matching clinical trials. As described herein, the clinical trial matcher pulls information from the patient's medical record such as the biomarkers that are identified as being positive for the patient, and uses this information in order to generate a listing of trials that may be applicable to the individual. Thus, the individual does not need to input particular information about their disease and/or biomarkers which they show a positive result but rather this information can be pulled directly from the patient medical record and used by the system to provide a list of recommended trials. This single button approach which enables the user to find matching clinical trials by simply pressing on a single link can provide the advantage of a user-friendly method for searching for clinical trials that may be relevant for the individual. While the user clicks only a single button, the system identifies trials using the links between biomarkers identified in the patient, disease diagnosis, drugs associated with the biomarkers and the disease, and the trials associated with those drugs, diseases, or biomarkers. The system can further filter the information based on demographic factors such as age, sex, and location, presenting the user with a compact list of trials that are relevant for the patient.

Referring again to FIG. 1, the system includes a clinical trial database in addition to the patient database. The clinical trial database includes a clinical trial editor for inputting and storing information about clinical trials. An interface is used for enabling information about the clinical trial to be input and stored in the clinical trial database. Information about a clinical trial can include the clinical trial ID and associated URL, a title of the clinical trial, a brief title of the clinical trial, a summary, a description, outcomes, and study design. Additionally, the data about the clinical trial can include information about those who would be qualified to enroll in the clinical trial. This information may include the number of individuals participating or desired for participation in the study, the status of the clinical study for example whether it is currently recruiting for additional participants, the phase of the clinical trial, genders eligible for participation in the clinical trial, and the minimum age for participation in the clinical trial.

Interfaces and methods are also used to enable clinical trial administrators to identify matching patients for a particular clinical trial. As noted above, each clinical trial is associated with one or more biomarkers. These biomarkers can be displayed for example as the profile markers for a particular clinical trial. Additional biomarkers can be added to the records associated with a particular clinical trial. As described herein, the clinical trial matcher pulls information about the biomarkers associated with the clinical trial in order to identify potential matching patients. For example, if a trial administrator desires to find potential matching patients, the trial administrator can select the find matching patients link. Selection of this link will search the patient information to identify patients in the database that have positive results for the profile markers associated with the particular clinical trial. Additionally the list of matching patients can be filtered based on other criteria such as the enrollment criteria discussed herein.

Interfaces and methods are also provided as a biomarker editor. This editor allows the storage, editing, and display of curated information about each biomarker. Every biomarker listed in the biomarker editor contains a general description with associated literature references for the information. Each biomarker also includes a list of genetic alterations that have been observed or reported. Description of the genetic alterations, including the specific nucleotide change, the effect of that change on the encoded protein, and any functional information available about the variant, is shown; literature references are included. These descriptions and literature references are updated regularly, and time stamps indicate the date of most recent update. Also provided is a disease marker editor. This editor displays disease-specific information curated from the scientific literature, relevant to each gene or biomarker and each included variant of the gene or biomarker. Information is provided for multiple diseases in which the gene/biomarker or variant has been identified, and the information is highly referenced. In some embodiments, on the disease marker editor page, tabs allow for the association of literature references, cited in the text and sorted by gene/biomarker, variant and disease. Additional tabs allow the association of FDA-approved drugs (including descriptions and references) as well as sample clinical trials that may be relevant for that biomarker and variant in each disease.

A conventional computer system can be used for the operations described in association with any of the computer-implement methods described previously, according to one implementation. The system is intended to include various forms of digital computers, such as laptops, desktops, workstations, personal digital assistants, servers, blade servers, mainframes, and other appropriate computers. The system can also include mobile devices, such as personal digital assistants, cellular telephones, smartphones, and other similar computing devices. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system can include a processor, a memory, a storage device, and an input/output device. Each of the components is interconnected using a system bus. The processor is capable of processing instructions for execution within the system. The processor may be designed using any of a number of architectures. For example, the processor may be a CISC (Complex Instruction Set Computers) processor, a RISC (Reduced Instruction Set Computer) processor, or a MISC (Minimal Instruction Set Computer) processor.

In one implementation, the processor is a single-threaded processor. In another implementation, the processor is a multi-threaded processor. The processor is capable of processing instructions stored in the memory or on the storage device to display graphical information for a user interface on the input/output device.

The memory stores information within the system. In one implementation, the memory is a computer-readable medium. In one implementation, the memory is a volatile memory unit. In another implementation, the memory is a non-volatile memory unit.

The storage device is capable of providing mass storage for the system. In one implementation, the storage device is a computer-readable medium. In various different implementations, the storage device may be a floppy disk device, a hard disk device, an optical disk device, or a tape device.

The input/output device provides input/output operations for the system 1400. In one implementation, the input/output device includes a keyboard and/or pointing device. In another implementation, the input/output device includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While the present invention has been described with reference to certain embodiments thereof, it should be understood by those skilled in the art that various changes may be made and equivalents may be substituted without departing from the true spirit and scope of this invention. In addition, many modifications may be made to adapt to a particular situation, indication, material and composition of matter, process step or steps, without departing from the spirit and scope of the present invention. All such modifications are intended to be within the scope of the disclosure of the present invention.

What is claimed is:

1. A computer-implemented method for matching a patient for a clinical trial, comprising:
accessing, by a computer, a patient database comprising, for each of a plurality of patients, (a) electronic patient records comprising a patient identifier, a diagnosed disease and demographic information, and (b) testing results for one or more biomarkers;
accessing a clinical trial database comprising, for each of a plurality of clinical trials, (a) clinical trial records comprising a trial identifier, targeted disease, locations, (b) one or more biomarkers targeted by the clinical trial and (c) criteria on how testing results of the one or more biomarkers correlate with clinical trial outcomes; and
identifying a patient from the patient database as a suitable candidate patient for a clinical trial in the clinical trial database by matching the patient's disease, demographic information, and biomarker testing results with the clinical trial's target disease, locations and targeted biomarkers, respectively, wherein the matching of the biomarkers takes into consideration of the criteria such that the patient's testing results for the biomarkers predict positive outcomes from the clinical trial.

2. The method of claim 1, further comprising:
receiving a request for identifying a candidate patient for a clinical trial;
obtaining, for the clinical trial, clinical trial records comprising (a) targeted disease, locations, (b) one or more biomarkers targeted by the clinical trial and (c) criteria on how testing results of the one or more biomarkers correlate with clinical trial outcomes;
accessing the patient database; and
identify a patient from the patient database as the candidate patient, wherein the patient matches the clinical trial with respect to the clinical trial's target disease, locations and targeted biomarkers, and wherein the matching of the biomarkers takes into consideration of the criteria such that the patient's testing results for the biomarkers predict positive outcomes from the clinical trial.

3. The method of claim 1, further comprising:
receiving a request for identifying a candidate clinical trial for a patient;
obtaining, for the patient, (a) a diagnosed disease and demographic information, and (b) testing results for one or more biomarkers
accessing the clinical trial database; and
identifying a clinical trial from the clinical trial database as the candidate clinical trial, wherein the patient matches the clinical trial with respect to the patient's disease, demographic information and biomarkers, and wherein the matching of the biomarkers takes into consideration of the criteria such that the patient's testing results for the biomarkers predict positive outcomes from the clinical trial.
